(19) United States
(12) Patent Application Publication
(10) Pub. No.: US 2026/0348200 A1
(43) Pub. Date: Nov. 5, 2026

(54) ARTICLE TETHER

(71) Applicant: SE-KURE CONTROLS, INC., Franklin Park, IL (US)

(72) Inventor: Brandon Wong, Orland Park, IL (US)

(21) Appl. No.: 19/195,050

(22) Filed: Apr. 30, 2025

(51) Int. Cl. E05B 73/00; F16G 11/06

(52) U.S. Cl. CPC E05B 73/0005; F16G 11/06

(57) ABSTRACT

The combination of an article and a lasso. The lasso is made up of an elongate flexible component with a closed loop through which a part of the elongate flexible component can be directed to form a securing loop with a variable effective diameter. A blocking assembly is provided on the elongate flexible component and is configured to, in one state: a) block movement of the elongate flexible component relative to the closed loop in a manner that would effect enlargement of the effective diameter of the securing loop beyond a predetermined first effective diameter; and b) permit the effective diameter of the securing loop to be reduced from the first effective diameter.

### BACKGROUND OF THE INVENTION

### Field of the Invention

This invention relates to adjustable tethers, as used to engage articles to perform a security function and, more particularly, to an adjustable tether incorporating a safety feature.

### Background Art

Adjustable tethers, in the form of lassos, are used in numerous environments including, without limitation, in the security industry. In one of its simplest forms, a tether is formed by an elongate flexible component with an end portion doubled back on itself so as to define a fixed loop. A free end of the elongate flexible component is directed through the fixed loop to define an adjustable securing loop.

The adjustable tether may be used for many different purposes. As one example, the securing loop may be used to accumulate articles as by extending through and/or around portions thereof.

In the security industry, it is common to connect the securing loop to an article and to connect the free end portion to an anchoring location. With this arrangement, the engaged articles are confined in movement away from the anchoring location. The range of movement is dictated by the effective length of the elongate flexible component between the anchoring location and the article(s).

Tethers of this type may be purely mechanical in nature and/or may incorporate a conductive component extending lengthwise thereof to integrate an electronic monitoring feature.

Regardless of its particular construction and use, the lasso structure with an adjustable securing loop has the advantage that a generic form thereof can be adapted to many different applications. The ability to simply slide a length portion of the elongate flexible component through the fixed loop enables selection of securing loops with effective diameters that may vary over a substantial range, dictated by the overall length of the elongate flexible component.

This same versatility of the generic lasso also creates a potential safety problem. A lasso with the ability to form a securing loop of substantial diameter may tempt someone, such as a child, to direct a limb such as a hand or arm, or even a head, into the securing loop, creating the risk of entanglement with the elongate flexible component.

The ability to fix one or more different securing loop sizes is known. However, generally structures incorporated to achieve this end are relatively complicated compared to the desired overall simplicity of the lasso, and introduce inconvenience when the securing loop size is to be changed.

The industry constantly seeks out ways to make lasso-type structures that are affordable, convenient to operate, versatile in nature, and at the same time do not create unnecessary safety risks for persons using or otherwise manipulating them.

### SUMMARY OF THE INVENTION

In one form, the invention is directed to the combination of an article and a lasso. The lasso includes an elongate flexible component, a closed loop on the elongate flexible component through which a part of the elongate flexible component is directed to thereby define a securing loop, and a blocking assembly on the elongate flexible component. The securing loop has an effective diameter that is variable by changing an amount of the part of the elongate flexible component directed through the closed loop. The effective diameter of the securing loop: a) decreases as an incident of increasing an amount of the part of the elongate flexible component directed through the closed loop in one direction and b) increases as an incident of a portion of the part of the elongate flexible component directed through the closed loop being withdrawn from the closed loop by movement relative to the closed loop in a second direction opposite to the one direction. The blocking assembly is configured to have at least a first state wherein the blocking assembly: i) blocks movement of the part of the elongate flexible component in the second direction from the closed loop with the securing loop having a first predetermined effective diameter; and ii) permits direction of the part of the elongate flexible component through the closed loop in the one direction to thereby cause the effective diameter of the securing loop to be reduced from the first predetermined effective diameter. The securing loop extends at least one of: a) through an opening in the article; and b) around a part of the article.

In one form, the part of the elongate flexible component is a single length of the elongate flexible component.

In one form, the blocking assembly has a blocking piece that abuts to the closed loop.

In one form, the elongate flexible component has a length. The blocking piece is movable guidingly lengthwise along the elongate flexible component.

In one form, with the blocking assembly in the first state the blocking piece is blocked from being moved guidingly along the length of the elongate flexible component in a first direction beyond a first position wherein with the closed loop abutted to the blocking piece the securing loop has the first predetermined effective diameter and the part of the elongate flexible component is blocked from being further withdrawn from the closed loop by being moved in the second direction relative to the closed loop.

In one form, the blocking assembly has a locking part that with the blocking assembly in the first state is fixed to the elongate flexible component at a first location and blocks movement of the blocking piece guidingly along the length of the elongate flexible component in the first direction beyond the first position.

In one form, with the blocking assembly in the first state the blocking piece is movable guidingly along the length of the elongate flexible component oppositely to the first direction from the first position.

In one form, the locking part is configured to be selectively fixed at different locations along the length of the elongate flexible component.

In one form, the locking part is configured to be fixed at a second location spaced along the length of the elongate flexible component from the first location and when fixed at the second location blocks movement of the blocking piece along the length of the flexible component in the first direction beyond a second position wherein with the closed loop abutted to the blocking piece the securing loop has a second predetermined effective diameter that is different than the first predetermined effective diameter.

In one form, the blocking assembly has a releasable fastener that fixes the locking part relative to the elongate flexible component.

In one form, the blocking piece is a plate.

In one form, with the blocking assembly changed from the first state into a second state the locking part is guidingly movable along the length of the elongate flexible component.

In one form, the blocking piece is a plate with opposite sides. One of the opposite sides has a protrusion that abuts to the locking part.

In one form, the other of the opposite sides of the blocking piece is substantially flat and abuts the closed loop.

In one form, the releasable fastener is a threaded fastener.

In one form, the locking part has a ring-shaped body.

In one form, the elongate flexible component is a mechanical cable.

In one form, the elongate flexible cable is connected to a support relative to which the article is confined in movement a distance dictated by an effective length of the elongate flexible component.

### BRIEF DESCRIPTION OF THE DRAWINGS

FIG. 1 is a schematic representation of the combination of an article and a lasso, according to the invention;

FIG. 2 is a schematic representation of an adjustable securing loop defined using the lasso in FIG. 1;

FIG. 3 is a partially schematic representation of an exemplary form of lasso, as shown schematically in FIG. 1, and with an exemplary form of a blocking assembly, as also schematically depicted on the lasso in FIG. 1;

FIG. 4 is a fragmentary view of an elongate flexible component making up the lasso in FIG. 3 and showing a closed loop formed thereby and with a coating material removed to expose a core and crimping component;

FIG. 5 is a schematic representation of the elongate flexible component in FIG. 1 and showing a variation from the embodiment in FIGS. 3 and 4, to include one or more conductors;

FIG. 6 is a view of the lasso in FIG. 3 from a different perspective;

FIG. 7 is an enlarged, fragmentary view showing the cooperation between a blocking piece and locking part making up the inventive blocking assembly;

FIG. 8 is a perspective view of the blocking piece and locking part in FIG. 7 in a separated relationship;

FIG. 9 is a perspective view of a fastener for the locking part and a tool usable to reposition the fastener; and

FIG. 10 is a view of the inventive lasso as in FIG. 6 and with the effective diameter of the adjustable securing loop reduced.

### DETAILED DESCRIPTION OF THE PREFERRED EMBODIMENT

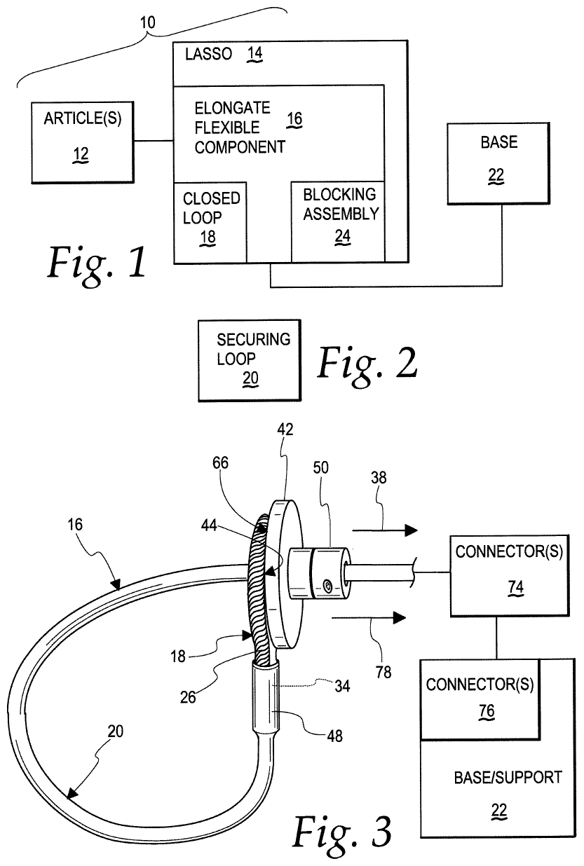

In FIG. 1, a schematic representation of components, according to the invention, is shown at 10. The combination 10 consists of at least one article 12 and a lasso 14.

The lasso 14 has an elongate flexible component 16 with a closed loop 18 defined thereon. A part of the elongate flexible component 16 is directed through the closed loop 18 to define a securing loop 20, as shown schematically in FIG. 2.

The schematic depiction of the components in FIGS. 1 and 2 is intended to encompass virtually an unlimited number of variations in the form thereof and the interactions of such components.

For example, the article 12 is not in any way limited in terms of nature or size. The lasso 14 may be connected to one or more such articles 12 which may be portable in nature. Alternatively, and without limitation, the lasso 14 may engage a movable part to control repositioning thereof relative to another part or parts, with this movable part being considered an article 12 as depicted in FIG. 1.

For example, the securing loop 20 may extend through a part of a gate or door to control repositioning thereof.

The lasso 14 may be used simply as a carrying device for an article or an accumulation device for multiple articles.

Alternatively, a part of the elongate flexible component 16 secured to an article 12 may be fixed to a base 22, establishing an anchoring location, as shown in U.S. Pat. No. 5,154,072, the disclosure of which is incorporated herein by reference. The elongate flexible component 16 may additionally include a conductor to incorporate electronic monitoring capabilities, as disclosed in U.S. Pat. No. 5,552,771, the disclosure of which is also incorporated herein by reference.

The closed loop 18 may be a separate element attached to the elongate flexible component 16 or may be formed otherwise, as by doubling a portion of the elongate flexible component 16 against itself and fixing that relationship by, without limitation, using a crimping component or the like.

In its simplest form, the securing loop 20 may be formed by directing a free end of the elongate flexible component 16 through the closed loop 18 in one direction. Alternatively, the elongate flexible component 16 may be formed into a different configuration with that part/portion being directed through the closed loop 18 to define the securing loop 20.

For purposes of simplicity, and without limitation, the invention will be described in an exemplary embodiment as being formed by directing a single length part of the elongate flexible component 16 through the closed loop 18 to define the securing loop 20.

In any event, the securing loop 20 has an effective diameter that is variable by changing an amount of the part of the elongate flexible component 16 that is directed through the closed loop 18.

More specifically, the effective diameter of the securing loop 20 is: a) decreased as an incident of increasing the amount of the part of the elongate flexible component directed through the closed loop in one direction; and b) increased as an incident of a portion of the part of the elongate flexible component 16 directed through the closed loop 18 being withdrawn from the closed loop by movement relative to the fixed loop 18 in a second direction opposite to the one direction.

A blocking assembly 24 on the elongate flexible component 16 is configured to have at least a first state wherein the blocking assembly 24: i) blocks movement of the part of the elongate flexible component in the second direction from the closed loop with the securing loop 20 having a first predetermined effective diameter; and ii) permits direction of the part of the elongate flexible component 16 through the closed loop 18 in the one direction to thereby cause the effective diameter of the securing loop to be reduced from the first predetermined effective diameter.

As noted, the securing loop 20 performs its function by at least one of extending: A) through an opening in one or more of the articles 12; and/or B) around a part of one or more of the articles 12.

Referring now to FIGS. 3-10, an exemplary form of the lasso 14, as schematically depicted in FIGS. 1 and 2, will be described. This specific form is exemplary in nature only and should not be viewed in any way as limiting.

The elongate flexible component 16 is shown as a mechanical component with a braided metal core 26. As noted, the nature of the elongate flexible component 16 is not limited. The core 26 might be made from a non-metal material and may, as shown schematically in FIG. 5, have a core 26 that incorporates one or more conductors 28 that may be used to facilitate electronic monitoring using a system as shown, for example, in U.S. Pat. No. 5,552,771.

In the depicted form, the closed loop 16 is formed by doubling an end length part 30 back against another part 32 of the elongate flexible component 16, with this relationship fixed by a crimping component 34.

The securing loop 20 in this embodiment is formed by directing a free end 36 of the elongate flexible component 16 through and relative to the closed loop 18 in one direction indicated by the arrow 38 in FIG. 3.

The securing loop 20 has an effective diameter that is variable by changing an amount of a part 40 of the elongate flexible component 16 directed through the closed loop 18. The part 40, as depicted generally in FIG. 6, is intended to be any length portion of the elongate flexible component 16 that can be moved in the one direction through the closed loop 18 and withdrawn from the closed loop 18 by movement relative thereto in a second direction, opposite to the one direction, which is indicated by the arrow 38 in FIG. 3.

The effective diameter of the securing loop 20 is: a) decreased as an incident of increasing the amount of the part 40 of the elongate flexible component 16 directed through the closed loop 18 in the one direction; and b) increased as an incident of at least a portion of the part 40 of the elongate flexible component 16, initially directed through the closed loop 18, being withdrawn from the closed loop 18 by movement relative to the closed loop 18 in the second direction.

The blocking assembly 24 consists of a blocking piece 42 that abuts to one side 44 of the closed loop 18, as seen clearly in FIG. 3. The blocking piece 42 has a through opening 46 through which the elongate flexible component 16 extends such that the blocking piece 42 is slidable guidingly along the length of the elongate flexible component 16.

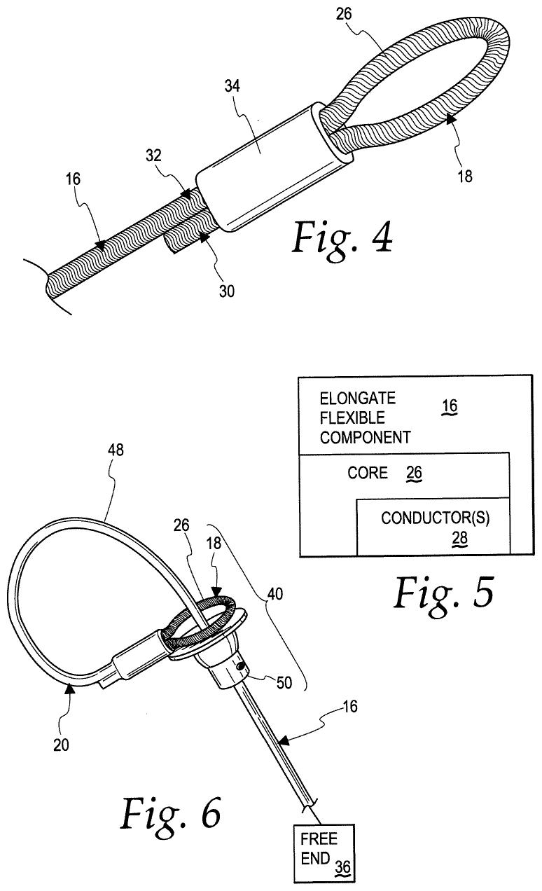

In this embodiment, the elongate flexible component 16 has a surrounding non-metal coating/sheath 48 which reduces the abrasiveness of the depicted braided core, provides a cushioning surface, and smoothly guides the blocking piece 42 lengthwise of the elongate flexible component 16. The sheath 48 also surrounds the crimping component 34 to shield sharp edges thereon. The sheath 48 is absent in FIG. 4 to facilitate description of the formation of the closed loop 18.

The blocking assembly 24 further consists of a locking part 50 that has a ring-shaped body 52 that surrounds the elongate flexible component 16 and is slidingly movable guidingly along the length of the elongate flexible component 16.

The blocking assembly 24 further consists of a releasable fastener 54 that is usable to selectively fix the locking part 50 at different lengthwise locations on the elongate flexible component 16. As depicted, the releasable fastener 54 is a threaded component directed through a threaded bore 56 on the body 52 to provide an inwardly projecting length that bears against the external surface of the elongate flexible component 16 to effect fixation. The fastener 54 has a fitting 58 to be engaged by a complementary fitting 60 on a tool 62 that can be used to tighten and release the fastener 54. The fitting 58 may be a conventional fitting, or one that is customized for security purposes.

The blocking piece 42 is formed as a plate that, without limitation, has a disk shape with an axis 64. With the blocking piece 42 in place, the axis 64 aligns generally with the lengthwise axis of the elongate flexible component 16 where it coextends therewith. In this relationship the locking part 50 has an effective diameter that will not readily pass, or cannot pass at all, through the closed loop 18.

In the depicted form, the blocking piece 42 has opposite sides, with one of the opposite sides 66, that abuts to the side 44 of the closed loop 18, being substantially flat.

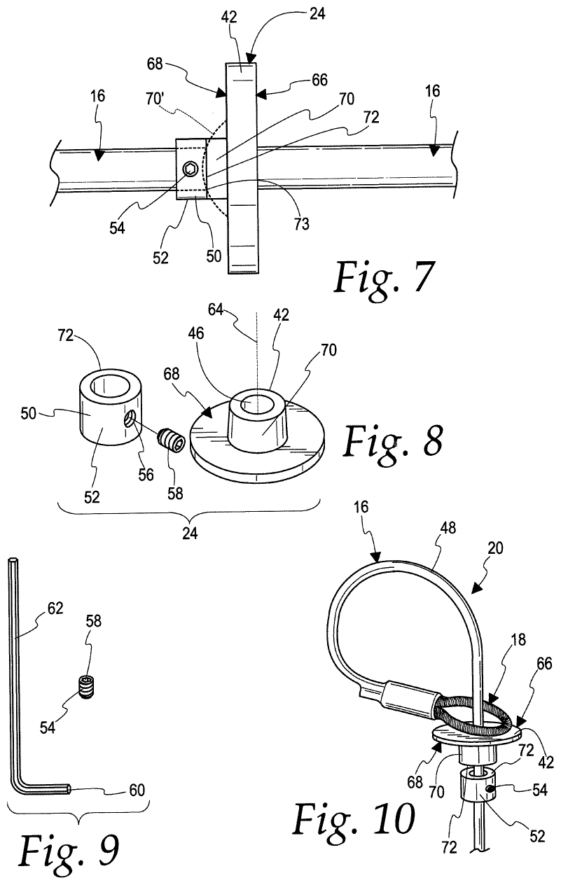

The other of the opposite sides at 68 has a discrete protrusion 70 that abuts an edge 72 on the locking part body 52. Alternatively, the protrusion 70′ may be convexly shaped, as shown in dotted lines in FIG. 7, to bear against an annular edge 73 on the locking part body 52, thereby guiding a modicum of relative pivoting movement between the locking part 50 and the blocking piece 42, to accommodate flexing of the elongate flexible component 16.

As shown in FIG. 3, the elongate flexible component 16 may be fixed to a base/support 22 of appropriate design, be it a fixed anchoring surface or an assembly specifically designed to accommodate the lasso 14 using cooperating connectors 74, 76, respectively on the lasso 14 and the base/support 22.

With this construction, with the free end 36 of the elongate flexible component 16 directed through the closed loop 18, the blocking piece 42, the loop 18, and the locking part 50 can be slid from the FIG. 3 position along the length portion of the elongate flexible component 16 towards, or fully up to, the connector 74-thereby effecting withdrawal of the aforementioned part 40 of the elongate flexible component 16 from the closed loop 18.

In the absence of the blocking assembly 24, the effective diameter of the securing loop 20 could be enlarged without restriction, other than at the base/support 24.

Similarly, with the blocking assembly 24 in one state, wherein the locking part 50 is freely slidable along the elongate flexible component 16, the blocking assembly 24 does not prevent enlargement of the effective diameter of the securing loop 20.

The state of the blocking assembly 24 is changed from this state to a first state by fixing the locking part 50 at a selected location along the length of the elongate flexible component 16 by tightening the fastener 54.

More specifically, as shown in FIG. 3, with the locking part 50 fixed at the depicted location, the blocking piece 42 is blocked against moving in the direction indicated by the arrow 78 along the length of the elongate flexible component 16 by the locking part 50. The closed loop 18 is in turn being blocked from shifting in this same direction by the blocking piece 42, thereby limiting the maximum size of the securing loop 20 to a predetermined effective diameter.

At the same time, the closed loop 18 is permitted to shift away from the blocking piece 42, oppositely to the direction of the arrow 78, which reduces the effective diameter of the securing loop 20.

In other words, using the above terminology, in FIG. 3, the blocking assembly 24 is in the first state and blocks movement of the part 40 of the elongate flexible component 16 in the second direction (opposite to the one direction indicated by the arrow 38 in FIG. 3) with the securing loop 20 having the predetermined effective diameter shown in FIG. 3. At the same time, direction of the part 40 of the elongate flexible component 16 through the closed loop 18 in the one direction, indicated by the arrow 38, is permitted to thereby cause the effective diameter of the securing loop 20 to be reduced from the predetermined effective diameter depicted in FIG. 3.

The locking part 50 can be conveniently repositioned and locked at different selected locations along the length of the elongate flexible component 16 to select a desired predetermined effective diameter. The user is thus allowed to select different predetermined effective diameters for the securing loop 20 which cannot be enlarged.

The foregoing disclosure of specific embodiments is intended to be illustrative of the broad concepts comprehended by the invention.

1. In combination:
an article; and
a lasso,
the lasso comprising:
an elongate flexible component;
a closed loop at an end of the elongate flexible component, the closed loop extending around a first opening through which a part of the elongate flexible component is directed to thereby define a securing loop,
the securing loop having an effective diameter that is variable by changing an amount of the part of the elongate flexible component directed through the first opening,
the effective diameter of the securing loop: a) decreasing as an incident of increasing an amount of the part of the elongate flexible component directed through the first opening in one direction and b) increasing as an incident of a portion of the part of the elongate flexible component directed through the first opening being withdrawn from the first opening by movement through the first opening in a second direction opposite to the one direction; and
a blocking assembly on the elongate flexible component and configured to have at least a first state wherein the blocking assembly: i) blocks movement of the part of the elongate flexible component in the second direction from the first opening with the securing loop having a first predetermined effective diameter; and ii) permits direction of the part of the elongate flexible component through the first opening in the one direction to thereby cause the effective diameter of the securing loop to be reduced from the first predetermined effective diameter,
the securing loop extending at least one of: A) through an opening in the article; and B) around a part of the article.

2. The combination according to claim 1 wherein the part of the elongate flexible component is a single length of the elongate flexible component.

3. The combination according to claim 1 wherein the blocking assembly comprises a blocking piece that: a) abuts to the closed loop; and b) cannot pass through the first opening.

4. The combination according to claim 3 wherein the elongate flexible component has a length and the blocking piece is movable guidingly lengthwise along the elongate flexible component.

5. The combination according to claim 4 wherein with the blocking assembly in the first state the blocking piece is blocked from being moved guidingly along the length of the elongate flexible component in a first direction beyond a first position wherein with the closed loop abutted to the blocking piece the securing loop has the first predetermined effective diameter and the part of the elongate flexible component is blocked from being further withdrawn from the first opening by being moved in the second direction relative to the closed loop.

6. The combination according to claim 5 wherein the blocking assembly comprises a locking part that with the blocking assembly in the first state is fixed to the elongate flexible component at a first location and blocks movement of the blocking piece guidingly along the length of the elongate flexible component in the first direction beyond the first position.

7. The combination according to claim 6 wherein with the blocking assembly in the first state the blocking piece is movable guidingly along the length of the elongate flexible component oppositely to the first direction from the first position.

8. The combination according to claim 6 wherein the locking part is configured to be selectively fixed at different locations along the length of the elongate flexible component.

9. The combination according to claim 6 wherein the locking part is configured to be fixed at a second location spaced along the length of the elongate flexible component from the first location and when fixed at the second location blocks movement of the blocking piece along the length of the flexible component in the first direction beyond a second position wherein with the closed loop abutted to the blocking piece the securing loop has a second predetermined effective diameter that is different than the first predetermined effective diameter.

10. The combination according to claim 6 wherein the blocking assembly comprises a releasable fastener that fixes the locking part relative to the elongate flexible component.

11. The combination according to claim 3 wherein the blocking piece comprises a plate.

12. The combination according to claim 6 wherein with the blocking assembly changed from the first state into a second state the locking part is guidingly movable along the length of the elongate flexible component.

13. The combination according to claim 6 wherein the blocking piece comprises a plate with opposite sides and one of the opposite sides has a protrusion that abuts to the locking part.

14. The combination according to claim 13 wherein the other of the opposite sides of the blocking piece is substantially flat and abuts the closed loop.

15. The combination according to claim 10 wherein the releasable fastener is a threaded fastener.

16. The combination according to claim 6 wherein the locking part has a ring-shaped body.

17. The combination according to claim 1 wherein the elongate flexible component is a mechanical cable.

18. The combination according to claim 1 wherein the elongate flexible cable is connected to a support relative to which the article is confined in movement a distance dictated by an effective length of the elongate flexible component.

19. The combination according to claim 1 wherein the closed loop is defined by a portion of the elongate flexible component that is doubled against itself.

20. The combination according to claim 1 wherein the article is a portable article.

21. The combination according to claim 1 wherein the closed loop has a fixed configuration.
